(19) United States
(12) Patent Application Publication
(10) Pub. No.: US 2007/0092607 A1
(43) Pub. Date: Apr. 26, 2007

(54) Barrier layer based on polyol

(75) Inventors: Andrew Gordon Johnston, Slough (GB); Jeremy Z. Meyer, Slough (GB)

Correspondence Address: FITZPATRICK CELLA HARPER & SCINTO, 30 ROCKEFELLER PLAZA, NEW YORK, NY, 10112, US

(73) Assignee: MARS INCORPORATED, McLean, VA (US)

(21) Appl. No.: 11/418,945

(22) Filed: May 5, 2006

Related U.S. Application Data
(63) Continuation of application No. 10/522,657.

(30) Foreign Application Priority Data
Jul. 23, 2002 (GB) 0217077.7

(51) Int. Cl. A23L 1/00

(52) U.S. Cl. 426/89

(57) ABSTRACT

A foodstuff comprising at least two components separated by a barrier layer, the barrier layer being a film of a polyol, polyol derivative or mixture thereof and a method for manufacturing such a foodstuff. The method comprises applying a polyol, a polyol derivative or mixture thereof to at least part of a surface of a first component to form a film thereon, and bringing at least part of a surface of a second component into contact with the film. The barrier layer is preferably formed by solidification of a molten polyol, polyol derivative or mixture thereof. A barrier layer formed by applying a film of polyol to a non-edible substrate.

The present invention relates to novel barrier layers for products such as foodstuffs and to methods of making the novel barrier layers.

The ingress of oxygen and migration of moisture, fat and/or other components in foodstuffs can often severely limit their shelf life. Such processes are difficult to suppress and can lead to oxidation, softening, blooming and invidious changes in taste, texture, smell and appearance of foodstuffs. The application of edible barrier layers, films or coatings to foodstuffs to obviate such problems is known in the art. These layers, films and coatings are intended to prevent, or at least reduce, either the ingress of oxygen or moisture from the atmosphere into a foodstuff or the migration of moisture, fat and/or other components between different layers or phases within a foodstuff. Typically, in foodstuffs where fat migration is likely to be an issue, rather than employing a barrier layer to obviate the problem, fat migration is avoided by manipulation of the ingredients of the foodstuff to omit or reduce the levels of those fats prone to migration.

Many known barrier layers, films or coatings suffer, however, from the disadvantages that they are difficult to apply, expensive or have an adverse effect on the taste or texture of foodstuffs to which they are applied. Furthermore, in order for known layers, films and coatings to be effective as barriers on foodstuffs it is often necessary to apply them in a thick layer, which exaggerates any detrimental effect upon the taste or texture they may have.

According to a first aspect of the present invention there is provided a foodstuff comprising at least two components separated by a barrier layer, the barrier layer being a film of a polyol, polyol derivative or mixture thereof.

The two components may be completely or partially separated from one another by the barrier layer.

Preferably, the barrier layer is formed by solidification of a molten polyol, polyol derivative or mixture thereof.

Preferably, the barrier layer covers at least 70% of the interface between the two components, more preferably at least 95%.

According to a second aspect of the present invention there is provided a barrier layer formed by applying a film of a polyol, polyol derivative or mixture thereof to a non-edible substrate.

Preferably, the barrier layer is formed by the application of a molten polyol, polyol derivative or mixture thereof to at least part of the surface of the non-edible substrate

According to a third aspect of the present invention there is provided a non-edible substrate having a barrier layer, the barrier layer being a film of a polyol, polyol derivative or mixture thereof.

Preferably, the barrier layer is formed by solidification of a molten polyol, polyol derivative or mixture thereof.

According to a fourth aspect of the present invention there is provided use of a film of a polyol, polyol derivative or mixture thereof to inhibit migration into a foodstuff of a liquid with which the foodstuff comes in contact.

According to a fifth aspect of the present invention there is provided use of a solidified molten polyol barrier layer to inhibit migration into a foodstuff of a liquid with which the foodstuff comes in contact.

Preferably, the thickness of the barrier layer is about 1.0 mm or less, more preferably about 0.5 mm or less.

Preferably, the barrier layer is substantially continuous.

Where the barrier layer is a barrier to moisture migration, preferably the polyol has a solubility at 25° C. of less than about 50 g/100 g H₂O, more preferably less than 30 g/100 g H₂O. Where the barrier layer is a barrier to moisture migration, preferably the polyol is at least one of mannitol, erythritol or isomalt, most preferably mannitol.

The barrier layer may comprise a single molten polyol or polyol derivative or a mixture of two or more polyols and/or polyol derivatives.

Preferably, the barrier layer comprises a mixture of at least 80% by weight mannitol and up to 20% by weight of other polyols or polyol derivatives, more preferably a mixture of at least 95% by weight mannitol and up to 5% by weight of other polyols or polyol derivatives.

The barrier layer may also comprise other common additives and ingredients such as colourants, flavourants, acidulants and plasticisers provided that the layer still provides an effective barrier against the migration of moisture, fat and/or other components.

According to a sixth aspect of the present invention there is provided a method of manufacturing a foodstuff comprising at least two components separated by a barrier layer, the barrier layer being a film of a polyol, polyol derivative or mixture thereof comprising: applying a polyol, polyol derivative or mixture thereof to at least part of a surface of a first component to form a film thereon; and bringing at least part of a surface of a second component into contact with the film.

Preferably, the step of forming a film on the first component comprises applying a molten polyol, polyol derivative or mixture thereof to at least part of the surface of the first component and solidifying the molten polyol, polyol derivative or mixture thereof.

Preferably, the polyol, polyol derivative or mixture thereof is applied to the first component by dipping the first component in a molten polyol, polyol derivative or mixture thereof.

Preferably, a mixture of at least 80% by weight mannitol and up to 20% by weight of other polyols or polyol derivatives is applied to the first component, more preferably a mixture of at least 95% by weight mannitol and up to 5% by weight of other polyols or polyol derivatives.

The hard, close packing crystalline or amorphous glass nature of barrier layers according to the invention makes them effective as protection against oxygen ingress and flavour and odour transfer.

Since the barrier layers produced according to the invention are odourless, colourless and clear or translucent, the invention also enables barriers to be applied to foodstuffs and non-edible substrates that do not adversely affect the smell or appearance of the foodstuffs or the non-edible substrates.

The thin barrier layers produced according to the invention are crisp/crunchy. The invention, therefore, also enables barrier layers to be applied to foodstuffs which advantageously enhance the crisp/crunchy texture of the foodstuffs.

A number of polyols, in particular mannitol, erythritol and isomalt, have a low degree of hygroscopicity and low solubility in water. By application of a thin layer of such polyols to substrates, the method of the invention enables barriers to be formed which provide effective and lasting protection against moisture migration. The invention also enables other polyols and/or polyol derivatives, such as maltitol, lactitol, sorbitol, xylitol and isomaltulose, having low solubilities in water at temperatures below 0° C., to be used to form barrier layers effective against moisture migration between components in frozen foodstuffs, for example on biscuits in ice cream.

Applying a thin, for example 0.5 mm or less, layer of a molten polyol, polyol derivative or mixture thereof to substrates produces an edible thin, solid, continuous barrier which has improved mechanical strength over for example known fat-based moisture barriers. By reducing the thickness of the layer required to produce an effective barrier, the present invention enables a barrier to be applied to foodstuffs which does not adversely affect the consumer acceptance of the foodstuffs.

The polyol barrier layers according to the present invention also exhibit improved temperature stability over known fat-based moisture barriers. Most fats liquify above 40° C. and higher melting waxes impart an unpleasant waxy mouth feel to foodstuffs or other substrates to which they are applied. In contrast to most fats, polyols melt at high temperatures, typically above 100° C., and the water solubility of, for example, mannitol increases only slightly with temperature.

The insolubility of polyols in fats and oils makes them suitable for use as barriers against fat migration. Through the formation of solid polyol barrier layers providing effective protection against fat migration, the present invention allows the production of multi-phase or component foodstuffs containing fats which are prone to migration.

The low viscosity of molten polyols enables solid barrier layers according to the invention to be formed by application of polyols to substrates by a wide variety of known techniques, such as dipping, spraying and enamelling. The low viscosity of molten polyols also aids their distribution over the surface of substrates. Consequently, solid barrier layers according to the invention are smooth and uniform.

The invention will be further described, by way of the following examples of specific embodiments thereof:

### EXAMPLE 1

100 cornflakes were dipped into 400 g of molten mannitol at 170° C. Each flake was submerged in the molten mannitol before being removed and any excess polyol shaken off. The flakes were then allowed to cool. Cold skimmed milk was then poured onto the dipped cornflakes and also onto eight equally sized portions of untreated cornflakes.

### EXAMPLE 2

300 g of mannitol was added to the remaining mannitol from Example 1 and the mixture reheated to 170° C. Whole, shortbread biscuits, halved shortbread biscuits and quartered shortbread biscuits were then dipped halfway into the molten mannitol, before being removed and allowed to cool. Once cool, the other halves of the shortbread biscuits were dipped in the molten mannitol and the biscuits then removed once again and allowed to cool. The biscuits were then floated in cold skimmed milk for 10 minutes.

### EXAMPLE 3

Shortbread biscuits were dipped in molten mannitol as in Example 2 and the biscuits allowed to cool. Once cool, approximately 15 holes were punched in the surface of the biscuits and half of each biscuit then submerged in hot coffee.

Example 1 produced cornflakes with a hard, continuous crystalline polyol layer over their entire surface. The polyol layer resulted in no change in the taste or sweetness of the cornflakes, but did result in a slightly crunchier texture compared to the untreated cornflakes. After 3 minutes in cold milk, the crunchiness of the untreated cornflakes began to deteriorate and after 4 minutes in cold milk the untreated cornflakes were no longer crunchy and very soggy. In contrast, after 20 minutes in cold milk the cornflakes with the polyol layer remained as crunchy as the untreated cornflakes were at the time the milk was added.

After 25 minutes in cold milk, the crunchiness of the cornflakes with the polyol layer began to deteriorate, resembling that of the untreated cornflakes after 3 minutes in milk.

Example 2 produced biscuits with a hard, continuous crystalline polyol layer over their entire surface. The polyol layer resulted in no change in the taste or sweetness of the biscuits, but did result in a slightly crunchier texture. After 10 minutes floating in milk, no moisture penetration of the polyol layer was observed.

Example 3 produced biscuits with a hard, continuous crystalline polyol layer over their entire surface as in Example 2. When the biscuits were dipped in hot coffee a darkening of the biscuits beneath the barrier layer was observed, indicating the absorption of coffee into the biscuits through the holes punched through the barrier layer. The barrier layer, however, remained intact.

Although in the above Examples the substrates were coated using molten mannitol, the same techniques may be employed to coat substrates with molten erythritol, isomalt or other polyols, polyol derivatives or mixture thereof. It will be appreciated that if molten erythritol or isomalt are used instead of molten mannitol a lower temperature may be employed due to the lower melting points of erythritol and isomalt compared to mannitol, about 124° C. and 147° C. respectively as compared to 167° C.

In all of the above Examples the substrates were dipped into the molten polyol in order to form the barrier layer. It will be readily appreciated that a variety of other techniques, such as spraying and enamelling, wherein the polyol is applied to the substrate as a powder and heat then applied to melt the polyol, could alternatively be employed.

While cornflakes and shortbread biscuits are employed as substrates in the Examples given above, it will be readily appreciated by those skilled in the art that barrier layers according to the invention may be applied to a wide variety of other edible and non-edible substrates. It will also be appreciated that while in Examples 1 and 2 the barrier layers are employed to reduce moisture migration, barrier layers according to the invention could be alternatively employed to reduce fat migration, oxygen ingress or odour or flavour transfer. In addition, because of their high mechanical strength and the ease with which they can be applied, it will be appreciated that barrier layers according to the invention may also be employed to prevent melt deformation or, as in Example 3, deformation due to moisture absorption.

It will also be appreciated that while in the above Examples a solid barrier layer was applied to the entire surface area of the substrate, barrier layers according to the invention may be applied to only part of the surface of a substrate. This may be desirable where for example only one surface of a substrate having low water activity is exposed to a high water activity phase. For example, a barrier layer according to the invention may be applied to one surface of a pizza base in order to prevent moisture migration into the base from toppings subsequently applied to that surface.

The application of a solid barrier layer according to the invention to only part of the surface area of a substrate will be further illustrated with reference to the accompanying drawings in which:

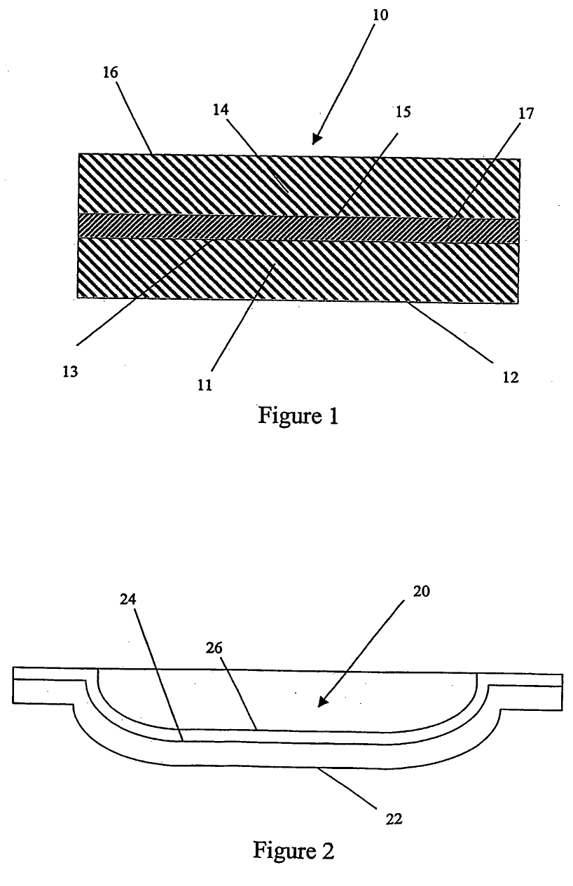

FIG. 1 shows a side elevation of a layered foodstuff comprising a barrier layer according to the invention.

FIG. 2 shows a cross-sectional view of a paper plate having a barrier layer according to the invention applied to its upper surface; and

FIG. 1 shows a layered foodstuff 10 comprising a biscuit layer 11 having a lower surface 12 and an upper surface 13, and a caramel layer 14 on top of the biscuit layer 11, having a lower surface 15, adjacent the upper surface 13 of the biscuit layer 11, and an upper surface 16. A barrier layer 17 according to the invention is applied to the upper surface 13 of the biscuit layer 11, which would otherwise be exposed to the lower surface 15 of the caramel layer 14. The barrier layer 17 reduces migration of moisture from the caramel layer 14 into the biscuit layer 11, thereby preventing the biscuit layer 11 from becoming soft and the caramel layer 14 from becoming dry and hard. The crisp, crunchy nature of the barrier layer 17 also enhances the crunchiness of the biscuit. It will be appreciated that barrier layers according to the invention could also be applied to the lower surface 12 of the biscuit layer 13 and/or upper surface 16 of the caramel layer 14 if desired, for example to prevent moisture ingress from the atmosphere into the biscuit if the lower surface 12 of the biscuit layer is exposed to the air.

Barrier layers according to the invention may be similarly applied for example confectionery products having a coconut creme layer to reduce migration of fat from the coconut into the remainder of the confectionery, for example to prevent discolouration of a chocolate layer which would otherwise be in contact with the coconut.

FIG. 2 shows a paper plate 20 having a lower surface 22 and an upper surface 24 which is exposed to foodstuffs during use of the plate. A barrier layer 26 according to the invention is applied to the upper exposed surface 24 of the plate 20 to reduce migration into the plate of moisture, fat and other components from foodstuffs placed on the upper surface 24, thereby preventing mechanical failure of the plate.

Barrier layers according to the invention may be similarly applied for example to the internal surfaces of paper cups to reduce migration into the cups of moisture from beverages contained therein and so prevent mechanical failure of the cups. The edible, colourless, clear or translucent and biodegradable nature of barrier layers according to the invention makes them particularly suitable for this purpose.

Examples of possible substrates to which barrier layers according to the invention could be advantageously applied include:

To Reduce Moisture Migration:

extruded kibbles in moist petfoods;

biscuits dispersed in ice creams;

breakfast cereals;

pizza bases;

biscuit in biscuit and caramel confectionery products;

bread or pastry in prepared sandwiches, wraps and baked goods;

paper plates; and

croutons.

To Reduce Fat Migration:

coconut creme or fat based centres in chocolate confectionery products;

paper plates;

wafers in wafer products with cream fillings; and

chocolate products to reduce soft fat migration driven bloom.

To Reduce Deformation;

chocolate bars/blocks to resist melt deformation in hot climates;

iced confections to resist melt deformation during non-chilled transport or storage; and

biscuits to resist deformation when dunked in hot or cold beverages.

1. A layered foodstuff comprising at least two component layers separated by a barrier layer, the barrier layer being a film of a solidified melt of at least one polyol.

2. A foodstuff according to claim 1 wherein the barrier layer has a thickness of 1.0 mm or less.

3. A foodstuff according to claim 1 wherein the barrier layer has a thickness of 0.5 mm or less.

4. A foodstuff according to claim 1 wherein the barrier layer covers at least 70% of the interface between the two component layers.

5. A foodstuff according to claim 1 wherein the barrier layer covers at least 95% of the interface between the two component layers.

6. A foodstuff according to claim 1 wherein the barrier layer is substantially continuous.

7. A foodstuff according to claim 1 wherein the barrier layer reduces migration of fat between the two component layers.

8. A foodstuff according to claim 1 wherein the barrier layer reduces flavour or odour transfer between the two component layers.

9. A foodstuff according to claim 1 wherein the barrier layer reduces migration of moisture between the two component layers.

10. A foodstuff according to claim 1 wherein the polyol has a solubility at 25° C. of less than 50 g/100 g H₂O.

11. A foodstuff according to claim 10 wherein the polyol has a solubility at 25° C. of less than 30 g/100 g H₂O.

12. A foodstuff according to claim 10, wherein the polyol is at least one of mannitol, erythritol or isomalt.

13. A foodstuff according to claim 1 wherein the barrier layer comprises at least 80% by weight mannitol and up to 20% by weight of other polyols or polyol derivatives.

14. A foodstuff according to claim 1 wherein the barrier layer comprises at least 95% by weight mannitol and up to 5% by weight of other polyols or polyol derivatives.

15. Use of a solidified molten polyol barrier layer to inhibit migration into a foodstuff of a liquid with which the foodstuff comes in contact.

16. Use according to claim 15 of at least one of mannitol, erythritol or isomalt.

17. Use according to claim 15 of a mixture of at least 80% by weight mannitol and up to 20% by weight of other polyols or polyol derivatives.

18. Use according to claim 17 of at least 95% by weight mannitol and up to 5% by weight of other polyols or polyol derivatives.

19. A method of manufacturing a layered foodstuff comprising at least two component layers separated by a barrier layer, the barrier layer being a film formed by solidification of at least one molten polyol comprising:
applying at least one molten polyol to at least part of a surface of a first component layer and solidifying the at least one molten polyol to form a film thereon; and
bringing at least part of a surface of a second component layer into contact with the film.

20. A method according to claim 19 wherein the at least one molten polyol is applied to the first component layer by dipping the first layer in the at least one molten polyol.

21. A method according to claim 19 comprising applying a mixture of at least 80% by weight mannitol and up to 20% by weight of other polyols or polyol derivatives to the first component layer.

22. A method according to claim 19, comprising applying a mixture of at least 95% by weight mannitol and up to 5% by weight of other polyols or polyol derivatives to the first component layer.

23. A barrier layer comprising at least 80% by weight mannitol and up to 20% by weight of other polyols or polyol derivatives, the barrier layer being a film of a solidified melt of mannitol and, where present, other polyols or polyol derivatives on a non-edible substrate.

24. A barrier layer according to claim 23 comprising at least 95% by weight mannitol and up to 5% by weight of other polyols or polyol derivatives.

25. A non-edible substrate having a barrier layer comprising at least 80% by weight mannitol and up to 20% by weight of other polyols or polyol derivatives, the barrier layer being a film of a solidified melt of mannitol and, where present, other polyols or polyol derivatives.

26. A non-edible substrate according to claim 25 wherein the barrier layer comprises at least 95% by weight mannitol and up to 5% by weight of other polyols or polyol derivatives.

27-31. (canceled)
